(19) United States
(12) Patent Application Publication
(10) Pub. No.: US 2023/0369575 A1
(43) Pub. Date: Nov. 16, 2023

(54) LITHIUM-DOPED SILICON OXIDE COMPOSITE ANODE MATERIAL WITH HIGH INITIAL COULOMBIC EFFICIENCY AND PREPARATION METHOD THEREOF

(71) Applicant: Guangdong Kaijin New Energy Technology Co., Ltd., Dongguan (CN)

(72) Inventors: Rusheng Fu, Dongguan (CN); Dexin Yu, Dongguan (CN); Yonglong Wang, Dongguan (CN); Yunlin Yang, Dongguan (CN)

(21) Appl. No.: 18/351,738

(22) Filed: Jul. 13, 2023

(30) Foreign Application Priority Data
Aug. 8, 2022 (CN) 202210943730.X

(51) Int. Cl. H01M 4/36; H01M 4/38; H01M 4/58; H01M 4/62; C04B 35/16; C04B 35/628

(52) U.S. Cl. CPC H01M 4/366; H01M 4/364; H01M 4/386; H01M 4/5825; H01M 4/625; C04B 35/16; C04B 35/62839; H01M 2004/027

(57) ABSTRACT

A lithium-doped silicon oxide composite anode material with high initial Coulombic efficiency and a preparation method are provided, which relates to the field of anode materials for lithium batteries. The material includes nano-silicon, lithium silicate and a conductive carbon layer. A diffraction peak intensity of Li₂Si₂O₅(111) with 2θ being 24.7±0.2° in an XRD pattern of the lithium-doped silicon oxide composite anode material is I1, a diffraction peak intensity of Li₂SiO₃(111) with 2θ being 26.8±0.3° in the XRD pattern is I2, and I1/I2<0.25. The material provided in the present invention has a specific phase composition ratio, thereby achieving the effect of high initial Coulombic efficiency and high specific capacity.

### FIELD OF THE INVENTION

The present application relates to the field of anode materials for lithium batteries, in particular to a lithium-doped silicon oxide composite anode material with high initial Coulombic efficiency and a preparation method thereof.

### BACKGROUND OF THE INVENTION

Lithium-ion batteries have been widely used in portable electronic products and electric vehicles because of their advantages such as high operating voltage, long cycle life, no memory effect, less self-discharge, and environmental friendliness. At present, commercial lithium-ion batteries mainly use graphite-type anode materials, which cannot meet the needs of future lithium-ion batteries for high energy density due to their low theoretical specific capacity of 372 mAh/g. The promising Si has a high theoretical capacity up to 4200 mAh/g, nevertheless, the expansion ratio thereof is up to 300%, which affects the cycle performance, and results in marketing and application constraints accordingly. The corresponding silicon oxide material has better cycle performance, but a low initial Coulombic efficiency. At the initial charge, 20% to 50% of lithium is consumed to form SEI films and irreversible substances, which greatly reduces the initial Coulombic efficiency.

An effective way to improve the initial Coulombic efficiency of silicon oxide materials is lithium doping. During the lithiation process, SiO reacts with lithium to form inactive lithium silicates which decreases the irreversible lithium consumption to formation lithium silicates in the subsequently electrochemical measurement. After electrochemical lithium intercalation to the silicon oxide, lithium silicon alloy, lithium silicate and Li₂O may be formed, and the lithium silicate Li₂O·nSiO₂ (n denotes a modulus) may be many different kinds, such as Li₂O·2SiO₂ (Li₂Si₂O₅), Li₂O·SiO₂ (Li₂SiO₃), Li₂O·2/3SiO₂ (Li₆Si₂O₇), and Li₂O·1/2SiO₂ (Li₄SiO₄). Based on the Li—Si—O ternary phase diagram, Yasuda et al. performed a thermodynamic analysis on the phase evolution of lithium silicate during continuous lithiation of SiO, and the phase evolution follows, Li₂Si₂O₅→Li₂SiO₃→Li₄SiO₄, namely transitioned from high modulus to low modulus (referred to Thermodynamic Analysis and Effect of Crystallinity for Silicon Monoxide Negative Electrode for Lithium Ion, Batteries, J. Power Sources, 2016, 329, 462-472). When lithium is further intercalated, Li₄SiO₄ is decomposed into Li₁₃Si₄ and Li₂O. It's disclosed that with the increase of lithium intercalation content, the lithium silicate gradually transforms to the lithium silicate with high lithium content and low modulus, indicating that Li₂O and lithium silicate are reversible. In Unraveling the Reaction Mechanisms of SiO Anodes for Li-Ion Batteries by Combining in Situ ⁷Li and ex Situ ⁷Li/²⁹Si Solid-State NMR Spectroscopy, J. Am. Chem. Soc. 2019, 141 (17), 7014-7027, lithium reaction of amorphous SiO was studied, and it's disclosed that Li₄SiO₄ can be transformed into Li₂SiO₃ during the deintercalation process of lithium, and the charge and discharge processes are reversible transformations between lithium intercalation products (Li₄SiO₄ and LiₓSi) and lithium deintercalation products (Li₄SiO₄, Li₂SiO₃ and SiOₓ). Solid-State NMR and Electrochemical Dilatometry Study on Li⁺ Uptake/Extraction Mechanism in SiO Electrode, J. Electrochem. Soc. 2007, 154 (12), A1112-A1117, and Nanosilicon Electrodes for Lithium-ion Batteries: Interfacial Mechanisms Studied by Hard and Soft X-ray Photoelectron Spectroscopy. Chem. Mater. 2012, 24 (6), 1107-1115, respectively reported the reversibility of Li₂O formed by lithium intercalation of silicon oxide. Therefore, less lithium is consumed during the lithium silicate transformation to the ultimate phase when the initial lithium silicate in the lithium-doped silicon oxide has lower modulus, which is conducive to improving the initial Coulombic efficiency of the silicon oxide anode material. By this token, the phase and relative content of lithium silicates in the lithium-doped silicon oxide material are closely related to their electrochemical properties. Due to the high water solubility of Li₄SiO₄, and the lithium-doped silicon oxide is generally washed through the impurity removal process, so it's difficult for Li₄SiO₄ to exist in the final lithium-doped silicon oxide material, but usually with residual lithium silicate Li₂SiO₃ and Li₂Si₂O₅. The pre-lithiated silicon oxide anode material in the prior art may have an improved initial Coulombic efficiency at a certain extent, nevertheless, still has a low initial Coulombic efficiency at 0.8V cutoff potential, such as ≤83.5%. While the current high nickel anode material has an initial Coulombic efficiency up to 90%, and the energy density of the cell in the future will be further provided, thus it's necessary to further improve the initial Coulombic efficiency at 0.8 V of the pre-lithiated silicon oxide anode material.

### SUMMARY OF THE INVENTION

To solve the above-mentioned technical problems, the present invention provides a lithium-doped silicon oxide composite anode material with high initial Coulombic efficiency which has a specific phase composition ratio, high initial Coulombic efficiency and high specific capacity, and provides a corresponding preparation method. A specific technical solution follows.

In various embodiments of the present invention, a lithium-doped silicon oxide composite anode material with high initial Coulombic efficiency is provided, which includes nano-silicon, lithium silicate and a conductive carbon layer, wherein a diffraction peak intensity of Li₂Si₂O₅(111) with 2θ being 24.7±0.2° in an XRD (X-Ray Diffraction) pattern of the lithium-doped silicon oxide composite anode material is I1, a diffraction peak intensity of Li₂SiO₃(111) with 2θ being 26.8±0.3° in the XRD pattern is I2, and I1/I2<0.25, for example, I1/I2<0.24, I1/I2<0.23, I1/I2<0.22, I1/I2<0.21, I1/I2<0.20, I1/I2<0.19, I1/I2<0.18, I1/I2<0.17, I1/I2<0.16, I1/I2<0.15, I1/I2<0.14, I1/I2<0.13, I1/I2<0.12, I1/I2<0.10, I1/I2<0.09, I1/I2<0.08, I1/I2<0.07, I1/I2<0.06, I1/I2<0.05, I1/I2<0.04, I1/I2<0.03, I1/I2<0.02, or I1/I2<0.01.

In some embodiments, a diffraction peak area of Li₂SiO₃(111) with 2θ being 26.8±0.3° in an XRD pattern of the lithium-doped silicon oxide composite anode material is A1, and a diffraction peak area of Si(111) with 2θ being 28.4±0.3° in the XRD pattern is A2, and A2/A1≥1.0, for example, A2/A1≥1.1, A2/A1≥1.2, A2/A1≥1.3, A2/A1≥1.4, A2/A1≥1.5, A2/A1≥1.6, A2/A1≥1.7, A2/A1≥1.8, A2/A1≥1.9, A2/A1≥2.0, A2/A1≥2.1, A2/A1≥22, A2/A1≥2.3, A2/A1≥2.4, A2/A1≥2.5, A2/A1≥2.6, A2/A1≥2.7, A2/A1≥2.8, A2/A1≥2.9, or A2/A1≥3.0.

In some embodiments, the lithium-doped silicon oxide composite anode material has a core-shell structure including a core and a shell, the core includes the nano-silicon and the lithium silicate, the lithium silicate includes either or both of Li₂SiO₃ and Li₂Si₂O₅, and the shell includes the conductive carbon layer distributed on a surface of the core, and optionally further includes a water-resistant coating.

In some embodiments, with the total mass of the lithium-doped silicon oxide composite anode material being 100 wt %, a mass percentage of a carbon material is 0.5 wt % to 10 wt %, such as 0.5 wt %, 0.6 wt %, 0.7 wt %, 0.8 wt %, 0.9 wt %, 1 wt %, 2 wt %, 2.5 wt %, 5 wt/%, 6 wt %, 7 wt %, 8 wt %, 9 wt % or 10 wt %, etc, and further preferably is 2 wt % to 6 wt %. The carbon material includes a coated carbon in the silicon oxide SiOₓ and a coated carbon in the water-resistant coating, and the content of the coated carbon of the water-resistant coating is 0.5 wt % to 4 wt % of the composite anode material, for example, 0.5 wt %, 0.6 wt %, 0.7 wt %, 0.8 wt %, 0.9 wt %, 1 wt %, 2 wt %, 2.5 wt %, 3 wt %, 3.5 wt %, 4 wt %.

In some embodiments, the nano-silicon is elemental silicon, and an average grain size of the nano-silicon is in a range of 3 nm to 20 nm. In some embodiments, the average grain size of the nano-silicon is in a range of 3 nm to 10 nm. In some embodiments, the average grain size of the nano-silicon is in a range of 4 nm to 8 nm.

In some embodiments, a particle size D50 of the lithium-doped silicon oxide composite anode material is in a range of 2 μm to 15 μm, and a particle size D90 of the lithium-doped silicon oxide composite anode material is in a range of 5 μm to 25 μm.

The term “D50”, as used herein, is intended to represent a particle size or a grain diameter of a sample with a percentage of cumulative particle size distribution of 50%. The physical meaning of D50 is that particles having a particle size larger than this diameter account for 50%, and particles having a particle size smaller than this diameter also account for 50%, thus D50 is also called as a median diameter or a median particle size. D represents the diameter of the powder particle, and D50 represents the diameter of the powder particle of 50% cumulative particle size (also called as 50% pass particle size).

The term “D90”, as used herein, is intended to represent a particle size or a grain diameter of a sample with a percentage of cumulative particle size distribution of 90%. The physical meaning of D90 is that particles having a particle size less than (or larger than) this diameter account for 90%.

The present invention further provides a preparation method of the lithium-doped silicon oxide composite anode material with high initial Coulombic efficiency mentioned above, and the preparation method includes the following steps:
S1, mixing a silicon oxide SiOₓ, a lithium source with a Li₂SiO₃ nucleating agent by a solid-phase mixing mode to form a pre-lithiated precursor;
S2, carrying out heat treatment on the pre-lithiated precursor under a vacuum or non-oxidizing atmosphere, and then depolymerizing and screening the pre-lithiated precursor to obtain a compound powder; and
S3, carrying out impurity removal and modification on the compound powder formed in Step S2 to obtain a lithium-doped silicon oxide composite anode material.

In some preferable embodiments, the present invention further provides a preparation method of the lithium-doped silicon oxide composite anode material with high initial Coulombic efficiency mentioned above, and the preparation method includes the following steps:
S1, mixing a silicon oxide SiOₓ, a lithium source with a Li₂SiO₃ nucleating agent by a solid-phase mixing mode to form a pre-lithiated precursor;
S2, carrying out heat treatment on the pre-lithiated precursor under a vacuum or non-oxidizing atmosphere, and then depolymerizing and screening the pre-lithiated precursor to obtain a compound powder; and
S3, carrying out impurity removal and modification on the compound powder formed in Step S2 to obtain an intermediate of a lithium-doped silicon oxide composite anode material; wherein as a wide explanation, the intermediate of a lithium-doped silicon oxide composite anode material also may be one of the forms of the lithium-doped silicon oxide composite anode material; and
S4, modifying the intermediate in Step S3 with a water-resistant coating to obtain a lithium-doped silicon oxide composite anode material.

Furthermore, by mass fraction, 100 parts of silicon oxide SiOₓ, 5 to 20 parts of lithium source, and 0.02 to 1 part of Li₂SiO₃ nucleating agent are included.

Furthermore, in the silicon oxide SiOₓ, 0.7≤x≤1.3.

Furthermore, the silicon oxide SiOₓ may be coated or uncoated with carbon. Alternatively, the silicon oxide SiOₓ is coated with carbon by either of gas-phase coating and solid-phase coating for example, and a mass percentage of the coated carbon in the silicon oxide SiOₓ is 0 to 6%, preferably 0.1% to 6%, for example, 0.1%, 0.2%, 0.3%, 0.4%, 0.5%, 0.6%, 0.7%, 0.8%, 0.9%, 1%, 2% 2.5%, 3%, 3.5%, 4%, 4.5%, 5%, 5.5%, or 6%.

Furthermore, organic carbon source gases used in the gas-phase coating may include at least one of methane, ethylene, acetylene, benzene, toluene, xylene, styrene and phenol.

Furthermore, the method of the gas-phase coating includes the following steps: placing the silicon oxide in a rotary furnace, introducing a protective atmosphere into the rotary furnace, heating to 600° C. to 1000° C., introducing an organic carbon source gas, holding the temperature for 0.5 h to 8 h, and then cooling to obtain a carbon-coated silicon oxide.

Furthermore, the carbon source in the solid-phase coating includes at least one of asphalt, polyethylene powder, saccharides, and organic acid.

Furthermore, the solid-phase coating includes the following steps: mixing the silicon oxide and the carbon source in a mixer at a speed of 300 rpm to 1500 rpm for 0.5 h to 4 h to obtain a carbon source-containing mixture, then placing the carbon source-containing mixture in a carbonization furnace for carbonization at a temperature of 600° C. to 1000° C. for 2 h to 8 h, and then cooling and discharging to obtain a carbon-coated silicon oxide composite material.

Furthermore, the lithium sources include at least one of lithium hydride, lithium alkylide, lithium metal, lithium aluminum hydride, lithium amide, lithium nitride, lithium carbide, lithium silicide and lithium borohydride.

Furthermore, the Li₂SiO₃ nucleating agent includes or is a rare earth metal oxide. In the present invention, the nucleating agent is beneficial to reduce the nucleation barrier of the Li₂SiO₃ and meanwhile accelerate the transformation from Li₂Si₂O₅ to Li₂SiO₃, thus under the same preparation process condition, more Li₂SiO₃ while less Li₂Si₂O₅ will be obtained in the lithium-doped silicon oxide composite anode material prepared after sintering, with the Li₂SiO₃ nucleating agent added.

Furthermore, the rare earth metal oxide may be selected from 15 lanthanide oxides with atomic numbers of 57 to 71 in the periodic table, and 17 oxides of scandium and yttrium with chemical properties similar to the lanthanide elements, and further preferably includes at least one of lanthanum oxide, cerium oxide, praseodymium oxide, neodymium oxide, samarium oxide and yttrium oxide.

Furthermore, a mixing time is 0.5 h to 10 h, a tool clearance width is 0.01 cm to 0.5 cm, and the mixer has a speed of 800 rpm to 2500 rpm.

Furthermore, the heat treatment is carried out at temperature of 550° C. to 900° C., for a treatment time of 2 h to 8 h. Furthermore, the heat treatment is carried out at temperature of 600° C. to 800° C., for example, 600° C., 650° C., 700° C., 750° C. or 800° C., etc. Optionally, the treatment time is 2 h to 5 h, for example, 2 h, 3 h, 4 h or 5 h.

Furthermore, the heat treatment is carried out in a non-oxidizing atmosphere, such as in an inert gas atmosphere preferably. The inert gas includes at least one of helium and argon.

Furthermore, the material resulted has a particle size D50 of 2 μm to 15 μm, a particle size D90 of 5 μm to 25 μm, and preferably, the particle size D50 is 3 μm to 10 μm, and the particle size D90 is 9 μm to 15 μm.

Furthermore, the impurity removal and modification in Step S3 is washing, and the composite powder prepared in Step S2 is soaked in solution A to remove active lithium from the surface of the lithium-containing silicide particles. The solution A may include one of alcohol, weak alkalis, weak acid and water, or a mixture of water and at least one of alcohol, weak alkalis and weak acid.

Furthermore, after the composite powder is soaked in the solution A, solid-liquid separation is carried out by centrifugation, extraction filtration or pressure filtration.

Furthermore, the solid obtained after solid-liquid separation is dried. A drying atmosphere may be air, a vacuum atmosphere or a non-oxidizing atmosphere. A drying temperature is 40° C. to 150° C. preferably 40° C. to 100° C. A drying time is 6 h to 48 h, and preferably 6 h to 24 h.

Furthermore, the water-resistant coating in Step S4 may be a hydrophobic polymer or a water-resistant inorganic substance, and preferably is a carbon coating. The carbon coating is coated on the surface of the core by either gas-phase coating or solid-phase coating, and preferably by gas-phase coating. The water-resistant coating is accounted for 0.5% to 4% of the mass of the composite anode material.

Furthermore, when the water-resistant coating is a carbon coating by gas-phase coating, the organic carbon source gases used in the gas-phase coating include at least one of methane, ethylene, acetylene, benzene, toluene, xylene, styrene and phenol. The method of the gas-phase coating includes the following steps: placing the silicon oxide in a rotary furnace, introducing a protective atmosphere into the rotary furnace, heating to 600° C. to 1000° C., introducing an organic carbon source gas, holding the temperature for 0.5 h to 8 h, and then cooling to obtain a lithium-doped silicon oxide composite anode material with high initial Coulombic efficiency with a water-resistant coating. Preferably, the protective atmosphere is nitrogen.

The present invention has the following beneficial effects.

Instead of focusing on doping element optimization or preparation process optimization of electrode plates to avoid material defects, or seeking new material phases to improve material properties, the invention directly focuses on the composition ratio of each phase of the material and provides a composition different from the conventional lithium-containing silicon oxygen composite anode material, namely a ratio of the diffraction peak intensity of Li₂Si₂O₅(111) I1 and that of Li₂SiO₃(111) I2, I1/I2<0.25, and a ratio of the diffraction peak area of Li₂Si₂O₅(111) A2 and that of Li₂SiO₃(111) A1, A2/A1≥1.0. During the lithium intercalation process of the silicon oxide anode material, lithium silicate is formed, and the phase of the lithium silicate formed is successively Li₂Si₂O₅, Li₂SiO₃ and Li₄SiO₄, with the increase of lithium intercalation. That is to say, the Li₂Si₂O₅ initially formed may be continually formed into Li₂SiO₃ phase, and the Li₂SiO₃ also may be continually formed into Li₄SiO₄ phase. Therefore, the type and relative content of the phase of the lithium silicate in the lithium-doped silicon oxide anode material are closely related to the initial Coulombic efficiency of the anode material. Specifically, since the lithium-doped silicon oxide anode material needs to be washed to remove impurities, and the Li₄SiO₄ phase is easily completely removed due to its excellent water solubility, so the relative content of Li₂Si₂O₅ and Li₂SiO₃ in the lithium-doped silicon oxide anode material is strongly related to the initial Coulombic efficiency of the anode material. According to the principle of lithium intercalation reaction of silicon oxide anode, the phase of lithium silicate in lithium-doped silicon oxide anode material includes Li₂Si₂O₅ and Li₂SiO₃. Higher initial Coulombic efficiency of the composite anode material can be obtained when the relative content of Li₂SiO₃ is higher. Therefore, the lithium-doped silicon oxide composite anode material has very small irreversible lithium consumption during the lithium intercalation process, and thus has high initial Coulombic efficiency and high specific capacity, specifically the initial Coulombic efficiency at 0.8V can be greater than 84%, and the reversible specific capacity at 0.8V can be greater than 1300 mAh/g. The preparation method provided by the invention is simple, environmentally friendly and pollution-free, which is suitable for large-scale industrial production.

### BRIEF DESCRIPTION OF THE DRAWINGS

The accompanying drawings facilitate an understanding of the various embodiments of this invention. In such drawings:

FIG. 1 is an XRD pattern of the material prepared in Embodiment 1-2 according to the present invention;

FIG. 2 is an XRD pattern of the material prepared in Embodiment 2-3 according to the present invention;

FIG. 3 is a scanning electron microscope (SEM) photograph of the material prepared in Embodiment 2-3 according to the present invention;

FIG. 4 is an initial charge-discharge curve chart of the material prepared in Embodiment 2-3 according to the present invention.

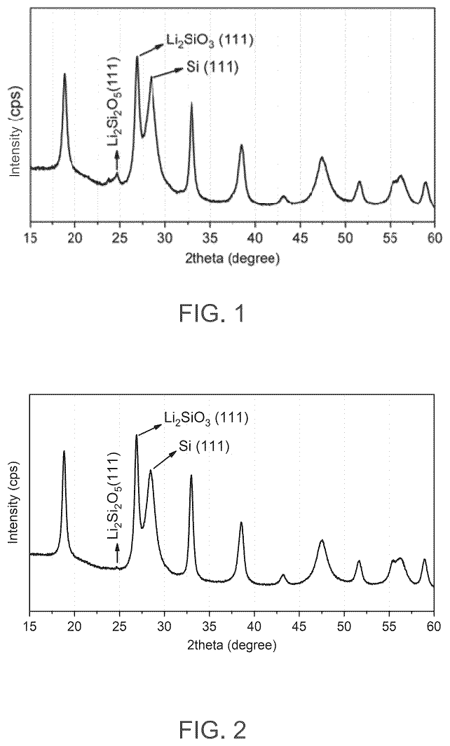

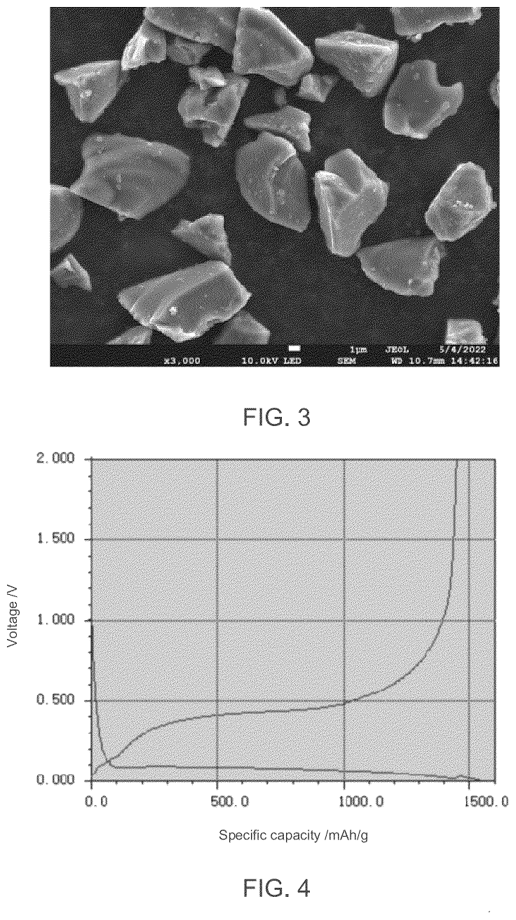

### DETAILED DESCRIPTION OF ILLUSTRATED EMBODIMENTS

The embodiments of the invention are described below by specific concrete examples, and persons skilled in the art can easily understand other advantages and functions of the invention from the contents disclosed in this specification. The invention may also be implemented or applied in other specific embodiments, and the details in this specification may also be modified or changed based on different points of view and applications without deviating from the spirit of the invention.

In order to better understand the invention, the following embodiments of the invention are further explained, which are not limited here however.

As a first aspect, the present invention provides a lithium-doped silicon oxide composite anode material with high initial Coulombic efficiency, which includes nano-silicon, lithium silicate and a conductive carbon layer, and optionally, may include a water-resistant coating at the surface. The diffraction peak intensity of Li₂Si₂O₅(111) with 2θ being 24.7±0.2° in an XRD (X-Ray Diffraction) pattern of the lithium-doped silicon oxide composite anode material is I1, the diffraction peak intensity of Li₂SiO₃(111) with 2θ being 26.8±0.3° in the XRD pattern is I2, and I1/I2<0.25.

Furthermore, for the lithium-doped silicon oxide composite anode material with high initial Coulombic efficiency, the diffraction peak area of Li₂SiO₃(111) with 2θ being 26.8±0.3° in the XRD pattern of the lithium-doped silicon oxide composite anode material is A1, and the diffraction peak area of Si(111) with 2θ being 28.4±0.3° in the XRD pattern is A2, and A2/A1≥1.0.

As a preferable embodiment of the present invention, the lithium-doped silicon oxide composite anode material has a core-shell structure including a core and a shell, the core includes the nano-silicon and the lithium silicate, the lithium silicate includes either or both of Li₂SiO₃ and Li₂Si₂O₅, and the shell includes a conductive carbon layer and/or a water-resistant coating distributed on the surface of the core.

In an exemplary embodiment, the diffraction peak intensity of Li₂Si₂O₅(111) with 2θ being 24.7±0.2° in the XRD pattern of the lithium-doped silicon oxide composite anode material is I1, the diffraction peak intensity of Li₂SiO₃(111) with 2θ being 26.8±0.3° in the XRD pattern is I2, and I1/I2<0.25.

Furthermore, the nano-silicon is elemental silicon, and an average grain size of the nano-silicon is in a range of 3 nm to 20 nm, preferably 3 nm to 10 nm, and more preferably 4 nm to 8 nm.

Furthermore, with the total mass of the lithium-doped silicon oxide composite anode material being 100 wt %, the mass percentage of the carbon material is 0.5 wt % to 10 wt %, such as 0.5 wt %, 1 wt %, 2 wt %, 2.5 wt %, 5 wt %, 6 wt %, 7 wt %, 8 wt %, 9 wt % or 10 wt %, etc, and further preferably is 2 wt % to 6 wt %. Furthermore, the lithium-doped silicon oxide composite anode material with high initial Coulombic efficiency has a particle size D50 of 2 μm to 15 μm and a particle size D90 of 5 μm to 25 μm.

As a second aspect, the present invention provides a preparation method of the lithium-doped silicon oxide composite anode material with high initial Coulombic efficiency mentioned above, which should not be construed as a limitation of the technical solution of the invention however. The method includes the following steps:
S1, mixing a silicon oxide SiOₓ, a lithium source with a Li₂SiO₃ nucleating agent by a solid-phase mixing mode to form a pre-lithiated precursor;
S2, carrying out heat treatment on the pre-lithiated precursor under a vacuum or non-oxidizing atmosphere, and then depolymerizing and screening the pre-lithiated precursor to obtain a compound powder; and
S3, carrying out impurity removal and modification on the compound powder formed in Step S2 to obtain an intermediate of a lithium-doped silicon oxide composite anode material; and
S4, modifying the intermediate in Step S3 with a water-resistant coating to obtain a lithium-doped silicon oxide composite anode material.

Furthermore, in Step S1, by mass fraction, 100 parts of silicon oxide SiOₓ, 5 to 20 parts of lithium source, 0.02 to 1 part of Li₂SiO₃ nucleating agent are included.

Furthermore, in the silicon oxide SiOₓ, 0.7≤x≤1.3.

Furthermore, the silicon oxide SiOₓ may be coated or uncoated with carbon. The carbon coating method may be gas-phase coating or solid-phase coating, and a mass percentage of a coated carbon in the silicon oxide SiOₓ is 0 to 6%.

Furthermore, organic carbon source gases used in the gas-phase coating may include at least one of methane, ethylene, acetylene, benzene, toluene, xylene, styrene and phenol.

Furthermore, the method of gas-phase coating includes the following steps: placing the silicon oxide in a rotary furnace, introducing a protective atmosphere into the rotary furnace, heating to 600° C. to 1000° C., introducing an organic carbon source gas, holding the temperature for 0.5 h to 8 h, and then cooling to obtain a carbon-coated silicon oxide.

Furthermore, the carbon source in the solid-phase coating includes at least one of asphalt, polyethylene powder, saccharides, and organic acid.

Furthermore, the solid-phase coating includes the following steps: mixing the silicon oxide and a carbon source in a mixer at a speed of 300 rpm to 1500 rpm for 0.5 h to 4 h to obtain a carbon source-containing mixture, then placing the carbon source-containing mixture in a carbonization furnace for carbonization at a temperature of 600° C. to 1000° C. for 2 h to 8 h, and then cooling and discharging to obtain the carbon-coated silicon oxide composite material.

Furthermore, the lithium sources include at least one of lithium hydride, lithium alkylide, lithium metal, lithium aluminum hydride, lithium amide, lithium nitride, lithium carbide, lithium silicide and lithium borohydride.

Furthermore, the Li₂SiO₃ nucleating agent includes at least one rare earth metal oxide.

Furthermore, the rare earth metal oxide may be selected from 15 lanthanide oxides with atomic numbers of 57 to 71 in the periodic table, and 17 oxides of scandium and yttrium with chemical properties similar to the lanthanide elements, and further preferably includes at least one of lanthanum oxide, cerium oxide, praseodymium oxide, neodymium oxide, samarium oxide and yttrium oxide.

Furthermore, a mixing time is 0.5 h to 10 h, a tool clearance width is 0.01 cm to 0.5 cm, and the mixer has a speed of 800 rpm to 2500 rpm.

Furthermore, the heat treatment in Step S2 is carried out at temperature of 550° C. to 900° C., for example, 550° C., 600° C., 650° C., 700° C., 750° C., 800° C., 850° C. or 900° C., and the treatment time is 2 h to 8 h. Preferably, the temperature of the heat treatment is 600° C. to 800° C., and the treatment time is 2 h to 5 h.

Furthermore, the heat treatment is carried out in a non-oxidizing atmosphere, such as in an inert gas atmosphere preferably. The inert gas includes at least one of helium and argon.

Furthermore, the powder material has a particle size D50 of 2 μm to 15 μm, a particle size D90 of 5 μm to 25 μm, and preferably, the particle size D50 is 3 μm to 10 μm, and the particle size D90 is 9 μm to 15 μm.

Furthermore, the impurity removal and modification in Step S3 is washing, and the composite powder prepared in Step S2 is soaked in solution A to remove active lithium from the surface of the lithium-containing silicide particles. The solution A may include one of alcohol, weak alkalis, weak acid and water, or a mixture of water and at least one of alcohol, weak alkalis and weak acid.

Furthermore, after the composite powder is soaked in the solution A, solid-liquid separation is carried out by centrifugation, extraction filtration or pressure filtration.

Furthermore, the solid obtained after solid-liquid separation is dried. A drying atmosphere may be air, a vacuum atmosphere or a non-oxidizing atmosphere. A drying temperature is 40° C. to 150° C., preferably 40° C. to 100° C. A drying time is 6 h to 48 h, and preferably 6 h to 24 h.

Furthermore, the water-resistant coating in Step S4 may be a hydrophobic polymer or a water-resistant inorganic substance, and preferably is a carbon coating. The carbon coating is coated on the surface of the core by either gas-phase coating or solid-phase coating, and preferably by gas-phase coating. The water-resistant coating is accounted for 0.5% to 4% of the mass of the composite anode material.

Furthermore, when the water-resistant coating is a carbon coating by gas-phase coating, the organic carbon source gases used in the gas-phase coating may include at least one of methane, ethylene, acetylene, benzene, toluene, xylene, styrene and phenol. The method of the gas-phase coating includes the following steps: placing the silicon oxide in a rotary furnace, introducing a protective atmosphere into the rotary furnace, heating to 600° C. to 1000° C., introducing an organic carbon source gas, holding the temperature for 0.5 h to 8 h, and then cooling to obtain a lithium-doped silicon oxide composite anode material with high initial Coulombic efficiency with a water-resistant coating.

As a third aspect, the present invention provides a lithium-ion battery including a lithium-doped silicon oxide composite anode material with high initial Coulombic efficiency according to the first aspect.

### Comparative Example 1—Lithium-Doped Silicon Oxide Composite Anode Material (A2/A1≥0.0, I1/I2>0.25)

S1, 100 parts by mass fraction of silicon oxide powder SiO_{0.7} that was uncoated with carbon and had a particle size D50 of 4.8 μm and a particle size D90 of 8.0 μm, and 20 parts by mass fraction of lithium amide were weighed, and subjected to VC mixing at a mixing speed of 600 rpm for a mixing time of 2 h, and a pre-lithiated precursor was obtained after mixing.

S2, the pre-lithiated precursor was placed in a box furnace and heat treated at a temperature of 550° C. for a holding time of 4 h, under an argon atmosphere. The material was cooled, and then depolymerized and screened to obtain a composite powder.

S3, the composite powder prepared in Step S2 was washed by a washing solvent of deionized water, with a mass ratio of the water and the composite power being 3:1, at a stirring speed of 300 rpm for a stirring time of 2 h. And then solid-liquid separation was carried out by suction filtration to obtain a wet mud material with a certain moisture content, and then the wet mud material was placed into a vacuum drying oven for drying at 80° C. for a drying time of 12 h, to obtain an intermediate of lithium-doped silicon oxide composite anode material.

S4, the intermediate prepared in Step S3 was coated with carbon by chemical vapor deposition, and then was placed in a CVD rotary furnace, with acetylene as the carbon source and nitrogen as the protective atmosphere, and deposited at 800° C. for 0.5 h. The material was then cooled and discharged, depolymerized, and screened for 400 meshes, to obtain a lithium-doped silicon oxide composite anode material, wherein the carbon content of the composite anode material was 0.5%.

### Comparative Example 2—Lithium-Doped Silicon Oxide Composite Anode Material (A2/A1≥1.0, I1/I2>0.25)

Raw material preparation: silicon oxide powder SiO_{0.89} with a particle size D50 of 2.5 μm and a particle size D90 of 5.0 μm was coated with carbon by chemical vapor deposition. The powder SiO_{0.89} was placed in a CVD rotary furnace with acetylene as the carbon source and nitrogen as the protective atmosphere, and deposited at 850° C. for 3.0 h. The material was then cooled and discharged to obtain a carbon-coated silicon oxide materia, wherein the carbon-coated amount was 4%.

S1, 100 parts by mass fraction of silicon oxide material prepared by the mentioned-above method and 12.5 parts by mass fraction of lithium hydride were weighed, and subjected to VC mixing at a mixing speed of 400 rpm for a mixing time of 3 h, and a pre-lithiated precursor was obtained after mixing.

S2, the pre-lithiated precursor was placed in a box furnace and heat treated at a temperature of 680° C. for a holding time of 8 h, under a nitrogen atmosphere. The material was cooled, and then depolymerized and screened to obtain a composite powder.

S3, the composite powder prepared in Step S2 was washed by a washing solvent of deionized water, with a mass ratio of the water and the composite power being 6:1, at a stirring speed of 500 rpm for a stirring time of 2 h. And then solid-liquid separation was carried out by press filtration, after that, the material was washed with anhydrous ethanol for 3 times to obtain a wet mud material with a certain moisture content, and then the wet mud material was placed in an air blast drying oven for drying at 80° C., for a drying time of 16 h, to obtain an intermediate of lithium-doped silicon oxide composite anode material.

S4, the intermediate prepared in Step S3 was coated with carbon by chemical vapor deposition, and then was placed in a CVD rotary furnace, with ethylene as the carbon source and nitrogen as the protective atmosphere, and deposited at 850° C. for 1 h. The material was cooled and discharged, depolymerized, and screened for 400 meshes, to obtain a lithium-doped silicon oxide composite anode material, wherein the carbon content of the composite anode material was 6%.

### Comparative Example 3—Lithium-Doped Silicon Oxide Composite Anode Material (A2/A1≥1.0, I1/I2>0.25)

Raw material preparation: silicon oxide powder SiO_{0.95} with a particle size D50 of 10.0 μm and a particle size D90 of 25.0 μm was coated with carbon by chemical vapor deposition. The powder SiO_{0.95} was placed in a CVD rotary furnace with methane as the carbon source and nitrogen as the protective atmosphere, and deposited at 1000° C. for 2.0 h. The material was then cooled and discharged to obtain a carbon-coated silicon oxide material, wherein the carbon-coated amount was 3%.

S1, 100 parts by mass fraction of silicon oxide material prepared by the mentioned-above method and 5 parts by mass fraction of lithium nitride were weighed, and subjected to VC mixing at a mixing speed of 400 rpm for a mixing time of 3 h, and a pre-lithiated precursor was obtained after mixing.

S2, the pre-lithiated precursor was placed in a box furnace and heat treated at a temperature of 900° C. for a holding time of 3 h, under an argon atmosphere. The material was cooled, and then depolymerized and screened to obtain a composite powder.

S3, the composite powder prepared in Step S2 was washed by a washing solvent of deionized water, with a mass ratio of the water and the composite power being 3:1, at a stirring speed of 500 rpm for a stirring time of 2 h. And then solid-liquid separation was carried out by press filtration, after that, the material was washed with anhydrous ethanol for 3 times to obtain a wet mud material with a certain moisture content, and then the wet mud material was placed in an air blast drying oven for drying at 80° C., for a drying time of 16 h, to obtain an intermediate of lithium-doped silicon oxide composite anode material.

S4, the intermediate prepared in Step S3 was coated with carbon by chemical vapor deposition, and then was placed in a CVD rotary furnace, with acetylene as the carbon source and nitrogen as the protective atmosphere, and deposited at 800° C. for 1 h. The material was cooled and discharged, depolymerized, and screened for 400 meshes, to obtain a lithium-doped silicon oxide composite anode material, wherein the carbon content of the composite anode material was 4.5%.

### Comparative Example 4—Lithium-Doped Silicon Oxide Composite Anode Material (A2/A1≥1.0, I1/I2>0.25)

Raw material preparation: silicon oxide powder SiO_{1.3} with a particle size D50 of 6.0 μm and a particle size D90 of 10.0 μm was coated with carbon by chemical vapor deposition. The powder SiO_{1.3} and asphalt at a mass percentage of 100:10 were weighed, and subjected to VC mixing at a mixing speed of 500 rpm for a mixing time of 3 h. The material was placed to a roller kiln for carbonization after uniform mixing, at a carbonization temperature of 900° C. for a holding time of 5 h. The material was then cooled and discharged to obtain a carbon-coated silicon oxide material, wherein the carbon-coated amount was 6%.

S1, 100 parts by mass fraction of silicon oxide material prepared by the mentioned-above method and 10.8 parts by mass fraction of lithium alkylide were weighed, and subjected to VC mixing at a mixing speed of 600 rpm for a mixing time of 2 h, and a pre-lithiated precursor was obtained after mixing.

S2, the pre-lithiated precursor was placed in a box furnace and heat treated at a temperature of 800° C. for a holding time of 5 h, under a nitrogen atmosphere. The material was cooled, and then depolymerized and screened to obtain a composite powder.

S3, the composite powder prepared in Step S2 was washed by a washing solvent of deionized water, with a mass ratio of the water and the composite power being 6:1, at a stirring speed of 500 rpm for a stirring time of 2 h. And then solid-liquid separation was carried out by press filtration, to obtain a wet mud material with a certain moisture content, and then the wet mud material was placed in an air blast drying oven for drying at 80° C., for a drying time of 16 h, to obtain an intermediate of lithium-doped silicon oxide composite anode material.

S4, the intermediate prepared in Step S3 was coated with carbon by chemical vapor deposition, and then was placed in a CVD rotary furnace, with ethylene as the carbon source and nitrogen as the protective atmosphere, and deposited at 850° C. for 2 h. The material was cooled and discharged, depolymerized, and screened for 400 meshes, to obtain a lithium-doped silicon oxide composite anode material, wherein the carbon content of the composite anode material was 10%.

The specific process parameters of the lithium-doped silicon oxide composite anode materials prepared in Comparative examples 1-4 are shown in Table 1.

TABLE 1
Specific process parameters in Comparative examples 1-4

| | | Carbon | Carbon | | | |
|---|---|---|---|---|---|---|
| | | coating | coating | | Treatment | |
| | O/Si in | of silicon | method | | temperature | Heat |
| | silicon | oxide | of silicon | Lithium | in S2 | treatment |
| | oxide | (wt %) | oxide | source | (° C.) | atmosphere |
| Comparative | 0.7 | 0 | None | Lithium | 550 | Ar |
| example 1 | | | | amide | | |
| Comparative | 0.89 | 4 | Gas-phase | Lithium | 680 | N₂ |
| example 2 | | | coating | hydride | | |
| Comparative | 0.95 | 3 | Gas-phase | Lithium | 900 | Ar |
| example 3 | | | coating | nitride | | |
| Comparative | 1.3 | 6 | Solid-phase | Lithium | 800 | N₂ |
| example 4 | | | coating | alkylide | | |

The dosing parameters of the lithium-doped silicon oxide composite anode materials prepared in Comparative examples 1-4 are shown in Table 2.

TABLE 2
Dosing parameters in Comparative examples 1-4

| | Parts by mass fraction | Parts by mass fraction |
|---|---|---|
| | of silicon oxide | of lithium source |
| Comparative | 100 | 20.0 |
| example 1 | | |
| Comparative | 100 | 12.5 |
| example 2 | | |
| Comparative | 100 | 5.0 |
| example 3 | | |
| Comparative | 100 | 10.8 |
| example 4 | | |

The following embodiments adopt the same processing steps and parameters as the corresponding Comparative example. The difference is that, the present embodiments additionally adds Li₂SiO₃ nucleating agent when mixing, and the addition method and the addition amount of the nucleating agent are shown in Table 3.

TABLE 3
Addition method and addition amount of
nucleating agent in Embodiments 1 to 4

| | Referenced | |
|---|---|---|
| | comparative | Addition method and addition amount of |
| | example | Li₂SiO₃ nucleating agent |
| Embodiment | Comparative | 0.15 wt % lanthanum oxide |
| 1-1 | example 1 | |
| Embodiment | Comparative | 1.0 wt % praseodymium oxide |
| 1-2 | example 1 | |
| Embodiment | Comparative | 0.02 wt % neodymium oxide |
| 1-3 | example 1 | |
| Embodiment | Comparative | 0.15 wt % neodymium oxide and 0.15 wt % |
| 2-1 | example 2 | lanthanum oxide |
| Embodiment | Comparative | 0.22 wt % cerium oxide |
| 2-2 | example 2 | |
| Embodiment | Comparative | 0.10 wt % yttrium oxide, 0.10 wt % |
| 2-3 | example 12 | neodymium oxide and 0.20 wt % |
| | | lanthanum oxide |
| Embodiment | Comparative | 0.20 wt % yttrium oxide |
| 3-1 | example 3 | |
| Embodiment | Comparative | 0.10 wt % praseodymium oxide |
| 3-2 | example3 | |
| Embodiment | Comparative | 0.20 wt % neodymium oxide |
| 3-3 | example 3 | |
| Embodiment | Comparative | 0.10 wt % cerium oxide and 0.25 wt % |
| 4-1 | example 4 | scandium oxide |
| Embodiment | Comparative | 0.35 wt % scandium oxide |
| 4-2 | example 4 | |
| Embodiment | Comparative | 0.30 wt % praseodymium oxide and |
| 4-3 | example 4 | 0.35 wt % neodymium oxide |

### Comparative Example 5—Lithium-Doped Silicon Oxide Composite Anode Material (A2/A1<1.0, I1/I2≥0.25)

Raw material preparation: silicon oxide powder SiO_{1.1} with a particle size D50 of 2.5 μm and a particle size D90 of 5.0 μm was coated with carbon by chemical vapor deposition. The powder SiO_{1.1} was placed in a CVD rotary furnace with acetylene as the carbon source and nitrogen as the protective atmosphere, and deposited at 850° C. for 3.0 h. The material was then cooled and discharged to obtain a carbon-coated silicon oxide material, wherein the carbon-coated amount was 4%.

S1, 100 parts by mass fraction of silicon oxide material prepared by the mentioned-above method and 12 parts by mass fraction of lithium hydride were weighed, and subjected to VC mixing at a mixing speed of 400 rpm for a mixing time of 3 h, and a pre-lithiated precursor was obtained after mixing.

S2, the pre-lithiated precursor was placed in a box furnace and heat treated at a temperature of 500° C. for a holding time of 8 h, under a nitrogen atmosphere. The material was cooled, and then depolymerized and screened to obtain a composite powder.

S3, the composite powder prepared in Step S2 was washed by a washing solvent of deionized water, with a mass ratio of the water and the composite power being 6:1, at a stirring speed of 500 rpm, for a stirring time of 2 h. And then solid-liquid separation was carried out by press filtration, after that, the material was washed with anhydrous ethanol for 3 times to obtain a wet mud material with a certain moisture content, and then the wet mud material was placed in an air blast drying oven for drying at 80° C., for a drying time of 16 h, to obtain an intermediate of lithium-doped silicon oxide composite anode material.

S4, the intermediate prepared in Step S3 was coated with carbon by chemical vapor deposition, and then was placed in a CVD rotary furnace, with acetylene as the carbon source and nitrogen as the protective atmosphere, and deposited at 700° C. for 0.5 h. The material was cooled and discharged, depolymerized, and screened for 400 meshes, to obtain a lithium-doped silicon oxide composite anode material, wherein the carbon content of the composite anode material was 4.5%.

### Comparative Example 6—Lithium-Doped Silicon Oxide Composite Anode Material (A2/A1<1.0, I1/I2≥0.25)

Raw material preparation: silicon oxide powder SiO_{1.0} with a particle size D50 of 2.5 μm and a particle size D90 of 5.0 μm was coated with carbon by chemical vapor deposition. The powder SiO_{1.1} was placed in a CVD rotary furnace with acetylene as the carbon source and nitrogen as the protective atmosphere, and deposited at 850° C. for 1.5 h. The material was then cooled and discharged to obtain a carbon-coated silicon oxide material, wherein the carbon-coated amount was 3%.

S1, 100 parts by mass fraction of silicon oxide material prepared by the mentioned-above method and 10 parts by mass fraction of lithium amide were weighed, and subjected to VC mixing at a mixing speed of 400 rpm for a mixing time of 3 h, and a pre-lithiated precursor was obtained after mixing.

S2, the pre-lithiated precursor was placed in a box furnace and heat treated at a temperature of 420° C. for a holding time of 16 h, under a nitrogen atmosphere. The material was cooled, and then depolymerized and screened to obtain a composite powder.

S3, the composite powder prepared in Step S2 was washed by a washing solvent of deionized water, with a mass ratio of the water and the composite power being 6:1, at a stirring speed of 500 rpm, for a stirring time of 2 h. And then solid-liquid separation was carried out by press filtration, after that, the material was washed with anhydrous ethanol for 3 times to obtain a wet mud material with a certain moisture content, and then the wet mud material was placed in an air blast drying oven for drying at 80° C., for a drying time of 16 h, to obtain an intermediate of lithium-doped silicon oxide composite anode material.

S4, the intermediate prepared in Step S3 was coated with carbon by chemical vapor deposition, and then was placed in a CVD rotary furnace, with acetylene as the carbon source and nitrogen as the protective atmosphere, and deposited at 650° C. for 1 h. The material was cooled and discharged, depolymerized, and screened for 400 meshes, to obtain a lithium-doped silicon oxide composite anode material, wherein the carbon content of the composite anode material was 3.5%.

### Comparative Example 7—Lithium-Doped Silicon Oxide Composite Anode Material (A2/A1<1.0, I1/I2<0.25)

Raw material preparation: silicon oxide powder SiO_{1.1} with a particle size D50 of 2.5 μm and a particle size D90 of 5.0 μm was coated with carbon by chemical vapor deposition. The powder SiO_{1.1} was placed in a CVD rotary furnace with acetylene as the carbon source and nitrogen as the protective atmosphere, and deposited at 850° C. for 3.0 h. The material was then cooled and discharged to obtain a carbon-coated silicon oxide material, wherein the carbon-coated amount was 4%.

S1, 100 parts by mass fraction of carbon-coated silicon oxide material prepared by the mentioned-above method and 12 parts by mass fraction of lithium hydride were weighed, and yttrium oxide, neodymium oxide and lanthanum oxide respectively accounted for 0.10%, 0.10% and 0.20% of the total mass of the material were added, the all were subjected to VC mixing at a mixing speed of 400 rpm for a mixing time of 3 h, and a pre-lithiated precursor was obtained after mixing.

S2, the pre-lithiated precursor was placed in a box furnace and heat treated at a temperature of 500° C. for a holding time of 8 h, under a nitrogen atmosphere. The material was cooled, and then depolymerized and screened to obtain a composite powder.

S3, the composite powder prepared in Step S2 was washed by a washing solvent of deionized water, with a mass ratio of the water and the composite power being 6:1, at a stirring speed of 500 rpm, for a stirring time of 2 h. And then solid-liquid separation was carried out by press filtration, after that, the material was washed with anhydrous ethanol for 3 times to obtain a wet mud material with a certain moisture content, and then the wet mud material was placed in an air blast drying oven for drying at 80° C., for a drying time of 16 h, to obtain an intermediate of lithium-doped silicon oxide composite anode material.

S4, the intermediate prepared in Step S3 was coated with carbon by chemical vapor deposition, and then was placed in a CVD rotary furnace, with acetylene as the carbon source and nitrogen as the protective atmosphere, and deposited at 700° C. for 0.5 h. The material was cooled and discharged, depolymerized, and screened for 400 meshes, to obtain a lithium-doped silicon oxide composite anode material, wherein the carbon content of the composite anode material was 4.5%.

### Comparative Example 8—Lithium-Doped Silicon Oxide Composite Anode Material (A2/A1<1.0, I1/I2<0.25)

Raw material preparation: silicon oxide powder SiO_{1.0} with a particle size D50 of 2.5 μm and a particle size D90 of 5.0 μm was coated with carbon by chemical vapor deposition. The powder SiO_{1.0} was placed in a CVD rotary furnace with acetylene as the carbon source and nitrogen as the protective atmosphere, and deposited at 850° C. for 1.5 h. The material was then cooled and discharged to obtain a carbon-coated silicon oxide material, wherein the carbon-coated amount was 3%.

S1, 100 parts by mass fraction of carbon-coated silicon oxide material prepared by the mentioned-above method and 10 parts by mass fraction of lithium amide were weighed, and yttrium oxide, neodymium oxide and lanthanum oxide respectively accounted for 0.10%, 0.30% and 0.30% of the total mass of the material were added, the all were subjected to VC mixing at a mixing speed of 400 rpm for a mixing time of 3 h, and a pre-lithiated precursor was obtained after mixing.

S2, the pre-lithiated precursor was placed in a box furnace and heat treated at a temperature of 420° C. for a holding time of 16 h, under a nitrogen atmosphere. The material was cooled, and then depolymerized and screened to obtain a composite powder.

S3, the composite powder prepared in Step S2 was washed by a washing solvent of deionized water, with a mass ratio of the water and the composite power being 6:1, at a stirring speed of 500 rpm, for a stirring time of 2 h. And then solid-liquid separation was carried out by press filtration, after that, the material was washed with anhydrous ethanol for 3 times to obtain a wet mud material with a certain moisture content, and then the wet mud material was placed in an air blast drying oven for drying at 80° C., for a drying time of 16 h, to obtain an intermediate of lithium-doped silicon oxide composite anode material.

S4, the intermediate prepared in Step S3 was coated with carbon by chemical vapor deposition, and then was placed in a CVD rotary furnace, with acetylene as the carbon source and nitrogen as the protective atmosphere, and deposited at 650° C. for 1 h. The material was cooled and discharged, depolymerized, and screened for 400 meshes, to obtain a lithium-doped silicon oxide composite anode material, wherein the carbon content of the composite anode material was 3.5%.

Product Testing

Test Methods

1. Crystal structure characterization: the crystal structure of the lithium-doped silicon oxide composite anode material prepared in the Embodiments and the Comparative examples was characterized. A powder diffractometer Xpert3 Powder of PANalytical in Netherlands was used for XRD tests, the test voltage was 40 KV, the test current was 40 mA, the scanning range was 10° to 90°, the scanning step was 0.008°, and the time of each step of scanning was 12 s.

The average grain size of Si in the material was characterized by an X-ray diffractometer, scanning was carried out within 10° to 90° of 2θ, then fitting was carried out within 26° to 30° of 2θ to obtain a half-peak width of a Si(111) peak, and finally, the average grain size of Si grains was calculated according to the Scherrer formula.

The diffraction peak area of Li₂SiO₃(111) with 2θ of 26.8±0.3° in an XRD pattern was A1, the diffraction peak area of Si(111) with 2θ of 28.4±0.3° in the XRD pattern was A2, and the ratio of A2 to A1 was calculated.

The peak area is calculated by fitting the XRD results with Jade 5.0, and the steps follow:
S1, setting the 2theta in a range of 26° to 30°;
S2, smoothing once, selecting a background (selecting the third option “Cubic spline” in Background function and Point Sampling), and clicking the button Apply;
S3, fitting the diffraction peak of Li₂SiO₃(111) (2theta=26.8±0.3°) and the diffraction peak of Si(111) (2theta=28.4±0.3°), and the calculated peak areas are denoted as A1 and A2, respectively.
S4, calculating a peak area ratio A2/A1.

The diffraction peak intensity of Li₂Si₂O₅(111) with 2θ of 24.7±0.2° in the XRD pattern is I1, the diffraction peak intensity of Li₂SiO₃(111) with 2θ of 26.8±0.3° in the XRD pattern is I2, and the ratio I1/I2 is calculated.

The peak intensity is calculated by analyzing the XRD results with Jade 5.0, and the steps follow:
S1, setting the 2theta in a range of 23° to 30°;
S2, smoothing once, selecting a background (selecting the third option “Cubic spline” in Background function and Point Sampling), clicking the button Apply, then clicking the button Remove;
S3, automatically marking peaks;
S4, recording the diffraction peak intensity of Li₂Si₂O₅(111) (2theta=24.7±0.2°) and the diffraction peak intensity of Li₂SiO₃(111) (2theta=26.8±0.3°) as I1 and I2, respectively;
S5, calculating a peak intensity ratio I1/I2.

2. Test of the first charge-discharge performance of button batteries: the lithium-doped silicon oxide composite anode materials prepared in the embodiments and the comparative examples were used as active substances to be mixed with a binder, namely an aqueous dispersion of an acrylonitrile multipolymer (LA132, solid content 15%), and a conductive agent (Super-P) according to a mass ratio of 70:10:20, a proper amount of water was added to be used as a solvent to prepare paste, and the paste was smeared on a copper foil, dried in vacuum and rolled to prepare anodes; with lithium metal as a counter electrode, CR2032 button batteries were assembled in a glove box filled with an inert gas with polypropylene microporous membranes as membranes, by means of 1 mol/L of an electrolyte which was a LiPF₆ three-component mixed solvent mixed according to EC:DMC:EMC=1:1:1(v/v). The charge-discharge performance of the button batteries was tested by means of a battery test system of LANHE. Specifically, under a normal temperature, the button batteries were discharged by lithium intercalation to 0.01 V at a constant current of 0.1 C, then further discharged by lithium intercalation to 0.005 V at a constant current of 0.02 C, and finally charged by lithium deintercalation to 1.5 V at a constant current of 0.1 C. An initial Coulombic efficiency at 0.8 V and 1.5 V was respectively calculated by taking a ratio of the charging capacity at 0.8 V and 1.5 V of the discharging capacity.

Other battery performance tests are carried out according to the general testing methods of the industry. The results are shown in Table 4, Table 5 and Table 6, respectively.

TABLE 4
Indicator and battery performance of lithium-doped silicon oxide
composite anode materials prepared in Comparative examples 1-4

| | | | | | | Initial |
|---|---|---|---|---|---|---|
| | | | Grain | | | Coulombic |
| | | | size of | Carbon | Capacity | efficiency |
| | | | silicon | content | at 0.8V | at |
| | I1/12 | A2/A1 | (nm) | (%) | (mAh/g) | 0.8V (%) |
| Comparative | 0.25 | 1.78 | 3 | 0.5 | 1310 | 81.0 |
| example 1 | | | | | | |
| Comparative | 0.42 | 1.80 | 6 | 6.0 | 1300 | 81.5 |
| example 2 | | | | | | |
| Comparative | 1.00 | 1.74 | 20 | 4.5 | 1320 | 78.4 |
| example 3 | | | | | | |
| Comparative | 0.65 | 1.94 | 9 | 10.0 | 1308 | 81.2 |
| example 4 | | | | | | |

TABLE 5
Indicator and battery performance of lithium-doped silicon
oxide composite anode materials with high initial Coulombic
efficiency prepared in each embodiment

| | | | | | Initial |
|---|---|---|---|---|---|
| | Referenced | | | Capacity at | Coulombic |
| | comparative | | | 0.8 V | efficiency at |
| | example | I1/I2 | A2/A1 | (mAh/g) | 0.8 V (%) |
| Embodiment | Comparative | 0.03 | 1.27 | 1320 | 84.0 |
| 1-1 | example 1 | | | | |
| Embodiment | Comparative | 0.13 | 1.63 | 1325 | 84.5 |
| 1-2 | example 1 | | | | |
| Embodiment | Comparative | 0.02 | 1.38 | 1333 | 85.5 |
| 1-3 | example 1 | | | | |
| Embodiment | Comparative | 0.05 | 1.29 | 1330 | 84.1 |
| 2-1 | example 2 | | | | |
| Embodiment | Comparative | 0.24 | 1.65 | 1340 | 87.0 |
| 2-2 | example 2 | | | | |
| Embodiment | Comparative | 0.01 | 1.49 | 1334 | 86.0 |
| 2-3 | example 2 | | | | |
| Embodiment | Comparative | 0.12 | 1.26 | 1327 | 84.3 |
| 3-1 | example 3 | | | | |
| Embodiment | Comparative | 0.03 | 1.35 | 1321 | 84.5 |
| 3-2 | example 3 | | | | |
| Embodiment | Comparative | 0.07 | 1.44 | 1328 | 84.2 |
| 3-3 | example 3 | | | | |
| Embodiment | Comparative | 0.22 | 1.71 | 1330 | 85.3 |
| 4-1 | example 4 | | | | |
| Embodiment | Comparative | 0.15 | 1.57 | 1336 | 85.5 |
| 4-2 | example 4 | | | | |
| Embodiment | Comparative | 0.05 | 1.33 | 1337 | 86.2 |
| 4-3 | example 4 | | | | |

TABLE 6
Indicator and battery performance of lithium-doped silicon oxide
composite anode materials prepared in Comparative examples 5-8

| | | | | | | Initial |
|---|---|---|---|---|---|---|
| | | | Grain | | | Coulombic |
| | | | size of | Carbon | Capacity | efficiency |
| | | | silicon | content | at 0.8V | at |
| | I1/12 | A2/A1 | (nm) | (%) | (mAh/g) | 0.8V (%) |
| Comparative | 0.27 | 0.71 | 4.1 | 4.5 | 1296 | 79.8 |
| example 5 | | | | | | |
| Comparative | 0.87 | 0.89 | 3.5 | 3.5 | 1287 | 79.5 |
| example 6 | | | | | | |
| Comparative | 0.15 | 0.83 | 4.0 | 4.5 | 1307 | 81.9 |
| example 7 | | | | | | |
| Comparative | 0.24 | 0.91 | 3.4 | 3.5 | 1318 | 81.4 |
| example 8 | | | | | | |

In Table 4, Groups 1 to 4 refer to the data of the product obtained in Comparative examples 1 to 4 respectively. In Table 5, Groups 1 to 3 refer to the data of the product obtained in Embodiment 1, Groups 4 to 6 refer to the data of the product obtained in Embodiment 2, Groups 7 to 9 refer to the data of the product obtained in Embodiment 3, and Groups 10 to 12 refer to the data of the product obtained in Embodiment 4. In Table 6, Groups 1 to 4 refer to the data of the product obtained in Comparative examples 5 to 8, respectively.

According to the records in Tables 4 to 6, comparing the Comparative example 1 with Embodiments 1-1 to 1-3, it's seen that, the composite anode material in the embodiments has decreased A2/A1 ratio, significant reduced I1/I2 ratio, increased capacity at 0.8V, and as well as improved initial Coulombic efficiency; comparing the Comparative example 2 with Embodiments 2-1 to 2-3, it's seen that, the composite anode material in the embodiments has increased capacity at 0.8 V, and as well as improved initial Coulombic efficiency; comparing the Comparative example 3 with Embodiments 3-1 to 3-3, it's seen that, the composite anode material in the embodiments has increased capacity at 0.8 V, and as well as improved initial Coulombic efficiency; and comparing the Comparative example 4 with Embodiments 4-1 to 4-3, it's seen that, the Embodiments 4-1 to 4-3 including an oxide nucleation agent with single or composite component can significantly increase the capacity and the initial Coulombic efficiency in material battery performance. From Comparative examples 5 and 8, it's seen that, the capacity and the initial Coulombic efficiency of the material battery performance are lower than those of the material provided by the present invention, when the composition of the composite anode material is beyond the scope of the invention, such as A2/A1<1.0, I1/I2<0.25; and the foregoing capacity and initial Coulombic efficiency are further weakened when A2/A1<1.0, I1/I2≥0.25.

A lithium-doped silicon oxide composite anode material with a specific parameter range (I1/I2<0.25, A2/A1≥1.0) is prepared in the present invention according to specific preparation process steps and parameters, thus a composite anode with higher initial Coulombic efficiency can be obtained, which has a promoting effect on the application of such materials in high energy density lithium-ion batteries.

Several preferable specific implementation modes and embodiments of the present invention are described in detail above, However, the present invention is not limited to the above-mentioned implementation modes and embodiments and embodiments. Within the scope of knowledge possessed by a person skilled in the art, various modifications or changes can be made without departing from the concept of the present invention.

What is claimed is:

1. A lithium-doped silicon oxide composite anode material, comprising nano-silicon, lithium silicate and a conductive carbon layer, wherein a diffraction peak intensity of Li₂Si₂O₅(111) with 26 being 24.7±0.2° in an XRD pattern of the lithium-doped silicon oxide composite anode material is I1, a diffraction peak intensity of Li₂SiO₃(111) with 2θ being 26.8±0.3° in the XRD pattern is I2, and I1/I2<0.25.

2. The lithium-doped silicon oxide composite anode material according to claim 1, wherein I1/I2<0.15.

3. The lithium-doped silicon oxide composite anode material according to claim 1, wherein I1/I2<0.05.

4. The lithium-doped silicon oxide composite anode material according to claim 1, wherein a diffraction peak area of Li₂SiO₃(111) with 2θ being 26.8±0.3° in an XRD pattern of the lithium-doped silicon oxide composite anode material is A1, and a diffraction peak area of Si(111) with 2θ being 28.4±0.3° in the XRD pattern is A2, and A2/A1≥1.0.

5. The lithium-doped silicon oxide composite anode material according to claim 4, wherein A2/A1≥1.3.

6. The lithium-doped silicon oxide composite anode material according to claim 1, wherein the lithium-doped silicon oxide composite anode material has a core-shell structure comprising a core and a shell, the core comprises the nano-silicon and the lithium silicate, the lithium silicate comprises either or both of Li₂SiO₃ and Li₂Si₂O₅, and the shell comprises the conductive carbon layer distributed on a surface of the core.

7. The lithium-doped silicon oxide composite anode material according to claim 6, wherein the shell further comprises a water-resistant coating.

8. The lithium-doped silicon oxide composite anode material according to claim 1, wherein, with a total mass of the lithium-doped silicon oxide composite anode material being 100 wt %, a mass percentage of a carbon material is 0.5 wt % to 10 wt %.

9. The lithium-doped silicon oxide composite anode material according to claim 8, wherein the carbon material comprises a coated carbon in a silicon oxide SiOₓ and a coated carbon in a water-resistant coating, and a content of the coated carbon of the water-resistant coating is 0.5 wt % to 4 wt % of the lithium-doped silicon oxide composite anode material.

10. The lithium-doped silicon oxide composite anode material according to claim 1, wherein the nano-silicon is elemental silicon, and an average grain size of the nano-silicon is in a range of 3 nm to 20 nm.

11. The lithium-doped silicon oxide composite anode material according to claim 1, wherein a particle size D50 of the lithium-doped silicon oxide composite anode material is in a range of 2 μm to 15 μm, and a particle size D90 of the lithium-doped silicon oxide composite anode material is in a range of 5 μm to 25 μm.

12. The lithium-doped silicon oxide composite anode material according to claim 1, wherein an initial Coulombic efficiency at 0.8V cutoff potential of the lithium-doped silicon oxide composite anode material is greater than 84%.

13. The lithium-doped silicon oxide composite anode material according to claim 1, wherein a reversible specific capacity at 0.8V cutoff potential of the lithium-doped silicon oxide composite anode material is greater than 1300 mAh/g.

14. A preparation method of the lithium-doped silicon oxide composite anode material according to claim 1, comprising steps of:
S1, mixing a silicon oxide SiOₓ, a lithium source with a Li₂SiO₃ nucleating agent by a solid-phase mixing mode to form a pre-lithiated precursor;
S2, carrying out heat treatment on the pre-lithiated precursor under a vacuum or non-oxidizing atmosphere, and then depolymerizing and screening the pre-lithiated precursor to obtain a compound powder; and
S3, carrying out impurity removal and modification on the compound powder formed in Step S2 to obtain a lithium-doped silicon oxide composite anode material.

15. The preparation method of the lithium-doped silicon oxide composite anode material according to claim 14, wherein, by mass fraction, 100 parts of the silicon oxide SiOₓ, 5 to 20 parts of the lithium source, and 0.02 to 1 part of the Li₂SiO₃ nucleating agent are included.

16. The preparation method of the lithium-doped silicon oxide composite anode material according to claim 14, wherein the Li₂SiO₃ nucleating agent comprises a rare earth metal oxide.

17. The preparation method of the lithium-doped silicon oxide composite anode material according to claim 14, wherein the Li₂SiO₃ nucleating agent comprises at least one of lanthanum oxide, cerium oxide, praseodymium oxide, neodymium oxide, samarium oxide and yttrium oxide.

18. The preparation method of the lithium-doped silicon oxide composite anode material according to claim 14, wherein in the silicon oxide SiOₓ, 0.7≤x≤1.3.

19. The preparation method of the lithium-doped silicon oxide composite anode material according to claim 14, wherein the silicon oxide SiOₓ is uncoated with carbon.

20. The preparation method of the lithium-doped silicon oxide composite anode material according to claim 14, wherein the silicon oxide SiOₓ is coated with carbon by either of gas-phase coating and solid-phase coating, and a mass percentage of a coated carbon in the silicon oxide SiOₓ is 0.1% to 6%.
